(19) United States
(12) Patent Application Publication
(10) Pub. No.: US 2002/0168296 A1
(43) Pub. Date: Nov. 14, 2002

(54) Device for the measurement of the carbon dioxide partial pressure

(76) Inventor: Rudolf Gambert, Wismar (DE)

Correspondence Address: FACTOR & PARTNERS, LLC, 1327 W. WASHINGTON BLVD., SUITE 5G/H, CHICAGO, IL, 60607, US

(21) Appl. No.: 10/133,292

(22) Filed: Apr. 25, 2002

(30) Foreign Application Priority Data
May 8, 2001 (DE) DE 10122150

(51) Int. Cl. G01N 27/00

(52) U.S. Cl. 422/98; 422/82.02; 422/82.01; 422/83; 422/90; 436/80; 436/84; 436/133; 436/149; 436/181

(57) ABSTRACT

The invention describes a new device for the measurement of the partial pressure of carbon dioxide. The device is based on a simple construction and can be manufactured in a cost effective way. The pH dependency of the redox potential of organic substances is used to determine an electrical characteristic that depends on the partial pressure of carbon dioxide. The device for the potentiometric determination of the partial pressure of carbon dioxide consists of a housing with an opening for the entrance for gases, a gas permeable membrane, an electrolyte, at least one redox and one reference electrode with electrode contacts that transmit the electrode potential outwards through the housing. The gas permeable membrane has an electronically conductive layer that works as a redox electrode for a pH dependent redox system. The pH dependent redox system is adsorbed, absorbed or chemically bound onto the electronically conductive layer and interacts electrochemically with the electrode such that the pH dependent redox potential adjusts at the electrode according to the present partial pressure of carbon dioxide.

### BACKGROUND OF THE INVENTION

1. Field of the invention

The invention describes a device for the measurement of the partial pressure of carbon dioxide.

2. Description of the Prior Art

The measurement of the partial pressure of carbon dioxide (CO₂) has a high relevance for industrial measurement techniques, personal protection and medical technology. Therefore many sensors based on different working principles are commercially available or have been described in the literature. The different types are fitted to every application, for instance concerning response time, precision or lifetime.

In industrial applications devices based on the measurement of infrared absorption are most prominent. Typical examples can be found e.g. in U.S. Pat Nos. 4,423,739, 5,464,982 and 5,696,379. The measurement gas is pumped or diffuses through or into a cuvette where the absorption is measured with a light source and an infrared detector compared to a reference. This measurement principle allows a very high accuracy. Given optimal mechanical, optical and electronic design very short response times and good long term stability can be reached. The use of narrow banded optical filters or selective light sources yields transducers with a high selectivity.

A disadvantage of this principle are the high manufacturing costs due to the required precision of the mechanical and the quality of the optical components. Another disadvantage of these systems is their sensitivity towards humidity and dust. Dust or condensing humidity in the cuvette lead to faulty measurements or decrease the precision considerably.

In gases such as stack gas or breath, that contain a high percentage of humidity, the cuvette has to be heated to avoid condensation. This heating in turn causes other disadvantages like a long warm up time of the measuring instrument. Their use in portable, battery operated instruments is also impaired because of the high power consumption which allows only short operating times. The use in explosive areas affords additional measures to make the whole instrument explosion proof.

Another measuring principle for carbon dioxide partial pressure is based on photoacoustics. Like at optical measurements the gas is introduced into a cuvette with a pulsed emitter and a microphone. The expansion and pulsatile pressure changes of the gas caused by its warming are recorded with a microphone. These devices are less expensive but more sensitive towards ambient sound and pressure effects. Therefore they are seldom used.

For gas mixtures up to 2 gases the measurement of sound propagation also can be used. Such devices are described in U.S. Pat. No. 5,841,017 and WO 9602820. A major drawback of this principle is the influence of other gases or vapors that have considerable influence on the precision. These transducers can only be used in certain gas mixtures and therefore are not often used.

Another invention which is described in WO 0004386 relates to the change in conductance when carbon dioxide dissolves in water. This can be described by the following equations:

CO₂+H₂O→HCO₃⁻+H⁺ Eq. (1)

and

HCO₃⁻+H₂O→CO₃²⁻+H⁺ Eq. (2)

When CO₂ dissolves in water ions are produced that lead to a change in conductance and the pH. The change in conductance correlates with the given partial pressure of CO₂ so that it can be used as a measure for the given CO₂ partial pressure. The disadvantage of such a device is that each change of conductance which also can be caused by the diffusion of small quantities of salts into the medium is interpreted as a change in the carbon dioxide partial pressure. Therefore its use is limited to special applications.

Transducers based on electrochemical principles can be manufactured in a cost effective way. They can be fitted for different special applications. Methods based on the direct reduction of CO₂ are described in the literature as well. In this amperometric method the reduction current is used as a measure of the partial pressure. Due to the high reduction potential of CO₂ a stoichiometric reduction in an aqueous electrolyte can only be achieved by the use of catalysts. It is known that such catalysts loose their activity over time and therefore recalibrations of the transducer are frequently necessary. In addition the catalyst can be poisoned by ambient factors which leads to loss of function.

Another electrochemical principle which is described in U.S. Pat. No. 5,071,526 is based on the redox properties of copper ions to generate a partial pressure property. A major drawback of this device is the sensitivity of copper ions towards traces of hydrogen sulfide, that is present in the ambience and leads to the formation of highly insoluble copper sulfide. The transducer gets damaged and has to be replaced.

In addition there are redox systems that have a redox potential that depends on the pH of the solution they are dissolved in. The system of quinone/hydroquinone is the simplest example for such a pH dependent redox system.

By using such redox systems the pH of a solution can be measured easily by determining the difference in potential between a redox electrode and an indifferent reference electrode, like a calomel or a silver/silver chloride electrode where the potential of the redox system adjusts reversibly.

In EP 0 247 941 a gas sensor is described that shall be suited to measure the partial pressure of CO₂. The sensor is made up from various layers one containing a redox system. It's pH dependent redox potential can be measured with a pH electrode. This design leads to a complex manufacturing procedure and does not allow to produce the device as a cheap disposable unit. In addition the layered structure causes long response times.

The known ‘Severinghaus Principle’ is a relatively cost effective method to measure the partial pressure of carbon dioxide reliably. It is based on the hydrolysis of carbon dioxide in an aqueous solution according to the Henderson-Hasselbalch equation:

pH=pK+log[HCO₃⁻]/[CO₂] Eq. (3)

It leads to a partial pressure dependent pH change of the electrolyte.

A classical construction is made up from a glass electrode in an aqueous electrolyte which contains hydrogen carbonate. The reference electrode is contained in the electrolyte or is integrated into the glass electrode. A change in the CO₂ partial pressure makes either more or less CO₂ permeate through a membrane or a gas permeable foil. According to the partial pressure the pH of the solution changes. An electrical signal is measured with the glass electrode against the reference electrode and can be displayed.

Modem methods make use of pH sensitive field effect transistors (FET) instead of the fragile and sensitive glass electrode. Assumed FETs would be mass fabricated they allow the design of cost effective transducers. The methods known as of today are still expensive and have long response times. For instance they are not suited to perform a breath by breath analysis that is required for some medical applications. Today's methods are only used for measurements where response time is not critical. For instance they are employed commercially for transcutaneous sensors that measure arterial CO₂ partial pressure through the skin and instruments for personal protection in mines. Competitive cost effective disposable sensors can not be designed due to the glass or iridium electrode or the FET as most expensive component of the device. In addition fast response times that are required for breath by breath measurements in medical applications are not achievable with this principle.

Therefore almost only optical transducers are used in medical technology since the other measuring principles lack the required fast response time of some seconds or are not precise enough in the relevant measurement range. For end tidal measurements of CO₂ concentrations even a response time below 500 milliseconds is necessary. Especially in medical technology there is a big need for cost effective and also fast sensors that can be used as a disposable. For instance they can be applied in emergency medicine and intensive care where a disposable has many advantages and the limited lifetime on the other hand does not mean a disadvantage as long as the price is competitive. Such sensors are not commercially available today.

### SUMMARY OF THE INVENTION

Referring to the state of the art it is the objective of the invention to provide a device that allows the measurement of carbon dioxide in a cost effective way, has a short response time and is insensitive to ambient conditions.

This object is attained by the characteristics of the main claim, further claims giving other details of the invention.

According to the inventive device the pH dependency of the redox potential of organic substances is used to determine an electrical response which depends on the partial pressure of carbon dioxide.

The device for the potentiometric determination of carbon dioxide consists of a housing with an opening for the entrance of gases, a gas permeable membrane, an electrolyte and at least one redox electrode and one reference electrode with electrode contacts, that transmit the potential of the electrodes outwards through the housing.

The gas permeable membrane has an electronically conducting layer that serves as a redox electrode for a pH dependent redox system. The pH dependent redox system is adsorbed, absorbed or chemically bound onto the electronically conductive layer. It interacts electrochemically with the electrode that the pH dependent redox potential adjusts at the electrode according to the present carbon dioxide partial pressure.

A change in the partial pressure of CO₂ leads to a rapid change of the pH of the electrolyte that in consequence leads to a change of the redox potential of the redox system. The difference between the redox potential and the reference electrode is measured.

The response time of the system depends on the gas exchange between the ambience and the electrolyte. On the other hand the system has to be sealed towards the outside to avoid leaking of the electrolyte. For a quick gas exchange membranes of hydrophobic, halogenated polymers like porous polytetrafluoroethylene (PTFE) can be used that show a high permeability for gases as well as being hydrophobic enough to avoid loss of electrolyte.

The electronically conductive layer that is used as a redox electrode consists of a noble metal, preferably gold, platinum, iridium or carbon.

The electrolyte contains potassium chloride, hydrogen carbonate and glycol. The hydrolysis of carbon dioxide or the adjusting of the equilibrium can be accelerated by the use of carbonic anhydrase in the electrolyte.

Preferably the adsorbed, absorbed or chemically bound pH dependent redox system is of the quinone type. The reference electrode consists typically of silver and silver chloride.

The inventive device can measure the partial pressure of carbon dioxide very fast. Due to the relative simple design it can be small in size. It is insensitive towards ambient conditions like humidity or oxygen in the measuring gas. It can be manufactured for a low price especially when the numbers are high. Therefore it is ideally suited for short term measurements or even as a disposable for medical technology or industrial applications.

### BRIEF DESCRIPTION OF THE DRAWING

FIG. 1 is a sectional view through a sensor according to the invention.

### BEST MODE FOR PRACTICING THE INVENTION

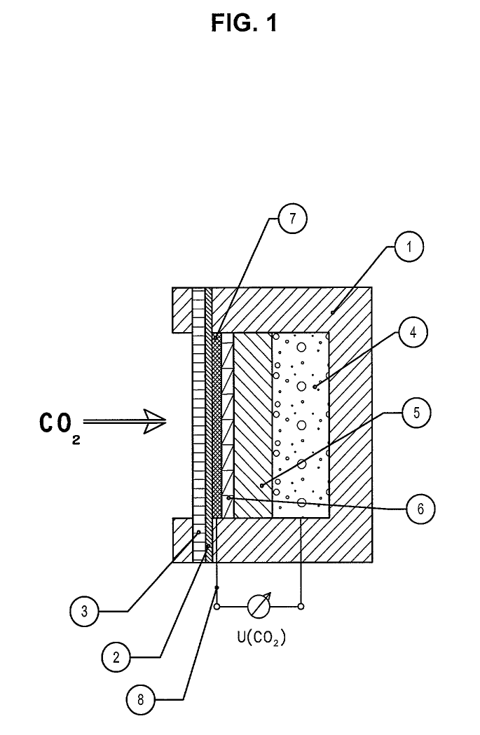

FIG. 1 shows a device for the fast measurement of a change in the partial pressure of carbon dioxide. In a housing (1) with an opening for gas entrance, with a hydrophobic protecting membrane (2) and a supporting grid (3), a first electrode (4) is located that consists of a coil of chlorinated silver wire which has a contact wire through the housing to the outside, a glass fibre wick filled with electrolyte (5), a porous plate of polyethylene soaked with electrolyte (6) and a porous hydrophobic membrane of FEP that is sputtered with an electrically conductive carbon layer (7) and is wetted with a mixture of electrolyte and a 104 molar quinehydrone solution. A thin contact wire of platinum (8) is pressed into the carbon layer and lead through the housing towards the outside.

This construction leads to very short diffusion ways for carbon dioxide diffusing either inwards or outwards and the volume of electrolyte interacting with carbon dioxide is limited. By this the response time of the system is very short.

The hydrophobic protecting membrane protects the sensor against dust and avoids the condensation of water or the formation of a water film when the device is used in humid environments.

The electrolyte is made up from a hydrous 0.1 molar potassium hydrogen carbonate and 0.05 molar potassium chloride solution.

An increase of the partial pressure of carbon dioxide leads to the diffusion of gas molecules through the protective membrane towards the porous membrane of fluoroethylenepropylene (FEP) that is sputtered with a layer of conducting carbon inwards. The thickness of the carbon layer is such that the pores of the membrane are not blocked and gas and electrolyte have free access. The carbon dioxide molecules dissolve in the boundary phase of the electrolyte and lower the pH according to Eq. 3. Quinhydrone that is also contained in the boundary phase shifts its redox potential which is measured via the carbon layer as redox electrode. Beside the diffusion time of the molecules the exchange current density of the redox electrode influences the response time of the sensor. The exchange current density is a property of the electrode material and the redox system.

It has been proven by own experiments that the exchange current density of quinones with graphite, conductive carbon, vitreous glass carbon and of noble metals are much higher than the mean diffusion times, also in a system as described before that has been optimized geometrically. The potential of the silver/silver chloride electrode remains constant. The change in potential difference between the redox electrode and the reference electrode therefore relates to changes in the partial pressure of carbon dioxide. The system reacts in the same way to a decrease of the partial pressure of carbon dioxide. In this case carbon dioxide diffuses out of the boundary phase until equilibrium with the ambience is reached. This difference in potential can measured simply with a voltmeter.

Alternatively a calibration function can be determined by using known CO₂ partial pressures that can be stored in an EPROM of the electronics. In addition the temperature behavior of the system can be stored in an EPROM and measured values can be corrected according to the actual temperature.

Due to the porous structure of the membranes and the coated redox electrode a quick adjustment of the electrochemical equilibrium is given since the diffusion ways are short. Alternatively to the coated membrane also very thin, porous and electrically conductive parts can be used as long as they can be made hydrophobic on the gas side. This can be reached e.g. by coating with PTFE.

Crucial for a short response time are short diffusion ways in the redox system and a high exchange current density of the redox system and the respective electrical lead.

Instead of carbon also very thin porous metal sinters or porous parts of glassy carbon or vitreous glassy carbon can be used.

Even shorter response times can be reached when quinoide structures with pH dependent redox potential are chemically synthesized on the surface of the carbon. Carbon is very well suited for this, since its surface can be modified quite easily by chemical synthesis. Also metal surfaces can be chemically modified with appropriate methods. For instance chemical vapor deposition (CVD) can be used to generate thin polymer layers, that can be chemically modified on their surface. Substances with quinoide structure can be linked by chemical synthesis using an ester or ether bond.

What is claimed is:

1. Device for the potentiometric determination of the partial pressure of carbon dioxide, comprising:
a housing with an opening for the entrance of gases, a gas permeable membrane, an electrolyte, at least one redox and one reference electrode with electrode contacts that transmit the electrode potential outwards through the housing,
said gas permeable membrane having an electronically conductive layer that works as the redox electrode for a pH dependent redox system, such that said pH dependent redox system is adsorbed, absorbed or chemically bound in said electronically conductive layer and interacts electrochemically with said electrode that the respective pH dependent redox potential adjusts at said electrode.

2. Device according to claim 1 wherein said membrane consists of hydrophobic halogenated polymers.

3. Device according to claim 1 wherein the electronically conductive layer that works as redox electrode consists of carbon or a noble metal especially gold, platinum, iridium.

4. Device according to claim 1 wherein said electrolyte contains potassium chloride, hydrogen carbonate and glycol.

5. Device according to claim 1 wherein said electrolyte contains carbonic anhydrase.

6. Device according to claim 1 wherein said adsorbed, absorbed or chemically bound redox system is of the quinone type.

7. Device according to claim 1 wherein said reference electrode consists of silver and silver chloride.
